(19) United States
(12) Patent Application Publication
(10) Pub. No.: US 2007/0244269 A1
(43) Pub. Date: Oct. 18, 2007

(54) Amines-epoxy compositions with high chemical resistance properties

(76) Inventors: Jan Dirk Bossaerts, Overijse (BE); Marc Jozef Rans, Oud-Heverlee (BE)

Correspondence Address: HEXION SPECIALTY CHEMICALS, INC., 1600 SMITH STREET, P.O. BOX 4500, HOUSTON, TX, 77210-4500, US

(21) Appl. No.: 11/729,233

(22) Filed: Mar. 28, 2007

(30) Foreign Application Priority Data
Oct. 21, 2004 (EP) 04077902.7

(51) Int. Cl. C08L 63/00; B32B 27/38

(52) U.S. Cl. 525/527

(57) ABSTRACT

The invention belongs to the field of epoxy resin curable compositions, more particularly an epoxy curable composition comprising aromatic halogenated glycidyl ether resins cured with amines, is intended to be used for the impregnation of fibers applicable or for the manufacturing of composite structures, laminations, coatings, floorings and putties applications which show particularly high resistance to aggressive chemicals.

### RELATED APPLICATION DATA

This application claims the benefit of European Patent Application No. 04077902.7 filed Oct. 21, 2004, the entire contents of which are hereby incorporated by reference.

### FIELD OF THE INVENTION

The invention relates to epoxy resin curable compositions, more particularly to epoxy curable compositions, comprising aromatic halogenated glycidyl ether resins to be cured with aliphatic amines, which are intended for the impregnation of fibers applicable to the manufacturing of composite structures, laminates, coatings, flooring and putties applications and which show a particularly high resistance to aggressive chemicals in which they are immersed.

The aromatic amines and more particularly the diamines were introduced at an early stage into the epoxy technology. They are recognized in the art as the cured networks that provide improved heat and chemical resistance over that attained with the aliphatic amines. The aromatic amines generally react slowly with glycidyl ethers and usually require heat to achieve a fully cured network and also the maximum properties. The most commonly used aromatic amine is from far 4,4′-methylenedianiline (MDA) which is a solid (or semi-solid) and therefore is not always easy to formulate into epoxy resin compositions. Proposed solutions to these problems were directed to the formulation of blends with other aromatic amines or to add diluents, U.S. Pat. No. 4,229,563 which discloses curing agents for epoxy resins derived from hydroxy or dihydroxy benzoic acid reacted with aliphatic polyamines. However, the chemical resistance of the cured films based thereof could not meet those of their obtained by curing with MDA based formulations. Therefore the need for an adequate alternative for the aromatic amine cured epoxy systems is still a current issue.

After extensive research and experimentation it has now surprisingly been found that a formulation comprising aromatic halogenated glycidyl ether resins could be cured with currently used aliphatic amines and leads to improved chemical resistant cured film over the epoxy systems known in the art.

An object of this invention is to provide an epoxy resin curable composition which is curable at ambient temperature and which provides a performance superior or equal to that on of the aromatic amine/epoxy resin cured compositions. The present invention provides compositions that fulfill this object.

Accordingly the present invention relates to a curable or polymerizable epoxy resin composition comprising an epoxy resin part (a) which comprises a combination of:
(a,i) at least an aromatic halogenated glycidyl ether resin,
(a,ii) a non halogenated glycidyl ether resin and
(a,iii) optionally a reactive diluent or/and a solvent,
and a hardener part (b) comprising aliphatic, cyclo-aliphatic, aromatic amines, and optionally a diluent and/or a solvent.

The aromatic halogenated glycidyl ether resins (a,i) used in this invention are derived from halogenated phenol reacted with a keto compound and subsequently with halohydrine and oligomers thereof. The most preferred halogen atoms are bromine and chlorine, the most preferred keto compounds are acetone and formaldehyde. Commercially available halogenated resins are for example EPON 1163, EPIKOTE 5123, EPIKOTE 5119 and EPIKOTE 5112 or any other glycidyl ether of tetra-bromo-Bis-Phenol derivatives which contains more than 10 weight % of brome on resinous material. (EPON and EPIKOTE are trademarks of Hexion Specialty Chemicals, Inc.)

The non halogenated epoxy resins (a,ii) used in the composition of this invention is a liquid or medium molecular weight solid resin or a mixture thereof. The epoxy resins used could also contain a generally known additive known in the art to improve flexibility and/or the adhesion capacity to the various substrates.

The preferred non halogenated epoxy resins (a,ii) for the composition of this invention are the diglycidyl ether of Bisphenol A, and/or Bisphenol F and/or polyglycidyl ethers of phenol/cresol-formaldehyde novolacs, and the like. Examples of such resins are: EPIKOTE 828, EPIKOTE 834, EPIKOTE 1001, EPIKOTE 1002, EPIKOTE 154, EPIKOTE 164.

The diluents could be non reactive such as for example benzyl alcohol or nonyl-phenol, or reactive such as a glycidyl ether derivative, a glycidyl ester derivative such as for example CARDURA E10 or hexadioldiglycidylether. (CARDURA is a trademark of Hexion Specialty Chemicals, Inc.) The solvent could be any solvent in which the above resins are soluble and could be used up to 80 weight % on resins (i) and (ii) and diluent.

The hardener part (b) of this invention consist of an aliphatic amine such as diethylenetriamine (DETA), triethylenetetramine (TETA), teraethylenepentamine (TEPA), isophorone diamine (IPD), para-aminocyclohexane methylene (PACM), diamino cyclohexane (DCH), meta-Xylene diamine (mXDA), 4,4′-Diamino 3,3′-dimethyl diCyclohexyl methane (DDCM) and adducts of aliphatic amines such as based on DETA,TETA,TEPA,IPD,PACM,DCH, mXDA, DDCM and the like. The most preferred are amines containing a cyclic structure such as IPD, PACM, mXDA and DCH or a mixture thereof. The aromatic amines such as MDA could be used as well even if they are not preferred for the reason discussed above in the introduction.

The most preferred non reactive diluent is benzyl alcohol.

The composition according to this invention could be formulated into a paint to protect metal parts, or for putty systems, or thin laminates such as the one used in tank lamination repair systems.

According to another embodiment of the present invention, therein before specified composition can be used in flooring applications where high chemical resistance is required.

According to still another aspect of the present invention, said above composition is that it could be used in making composite material with glass, carbon or natural fiber by the technology known in the art.

Test methods:

Reactivity of the Formulation

Procedure for the determination of the gelation time of blends of epoxy resin and curing agent.

Gelation time: the time in minutes required for a mixture of resin and curing agent, maintained at a fixed temperature, to reach the stage in the process of hardening at which the resistance to the movement of a slowly reciprocating plunger immersed in the mixture reaches a specific value.

Method summary: Heat the individual components to such a temperature that, after mixing, the final temperature of the mixture will be 0 to 2° C. below the test temperature. A 150 g mixture is prepared in a tin. A 100 g of the mixture is poured into the aluminum container. The plunger of the gel timer is moved up and down in the resin system. The time elapsed between the end of the mixing step (after 2 min mixing, the time=0), and the switching off of the gel timer is recorded.

Apparatus: Gel timer, according to BS 2782: Part 8, Method 835C, with disposable glass disk plungers. (Tecam Gel Timer, model GT3). Aluminum container: ID 40 to 47 mm, depth not less than 75 mm and wall thickness 0.35 to 0.51 mm.

Viscosity

Dynamic Viscosity of the mixture (resin+curing agent) in mPa.s, is measured according to ASTM D 2393. The temperature is 25° C. The apparatus used is a Brookfield DVII, with a spindle LV II (for low viscosities).

Fiber Wetting

Procedure for the determination of the fiber wetting behavior of blends of epoxy resin and curing agent.

Wetting time: the time in minutes, needed for 2 grams of the mixture to penetrate a glass fiber mat, until the surface goes from a glossy to a matt appearance (the mixture is absorbed by the glass mat).

Spot size: diameter of the spot in mm, after curing at 25° C. of the 2 grams of the mixture.

Glass mat: a chopped strand mat of size-coated chopped strands, with a thickness of 450 g/m².

Chemical Resistance

Procedure for the determination of chemical resistance of castings to different test media by immersion.

Preparation of the test pieces: Test specimens of the dimensions (80×10×4) mm were cut from the casting sheets by a diamond saw. Moulds used for the castings consisted of 2 steel plates with a 4 mm frame in between. The castings were cured in the mould.

Resistance test: The relative rate of absorption of the immersed test pieces was measured according to ASTM D570-98 Standard Test Method. The test media were demineralized water, toluene and aqueous HCl 10%.

The examples given in the description are not limiting the scope of this invention.

### EXAMPLES

Preparation of the formulations:

Epoxy resin part: The epoxy resin(s) is (are put in a glass reactor with heating jacket. The temperature is raised to 90° C. and stirred for 2 hours.

Composition

Resin 1: EPIKOTE 828L VE (37.5 weight %), EPIKOTE 1163 (37.5 w %), CARDURA E10 (25w %).

Resin 2: EPIKOTE 862 (42.5 weight %), EPIKOTE 1163 (42.5 w %), Heloxy 66 (15w %).

Resin 3: EPIKOTE 862 (37.5 weight %), EPIKOTE 1163 (37.5 w %) Heloxy 66 (25w %).

Comparative resin a: EPIKOTE 862 (42.5 weight %), EPIKOTE 828L VE (42.5 w %) Heloxy 66 (15w %).

Comparative resin b: EPIKOTE 154 (50 weight %), Heloxy 48 (50 w %).

Comparative resin c: EPIKOTE 816.

2. Hardener part: The hardener parts are mixed in a glass reactor at ambient temperature for 10 minutes. Note for the comparative hardener and the temperature in the glass reactor was 90° C. and the mixing time 2 hours.

Composition
Hardener 1: mXDA
Hardener 2: mXDA (80 w %) benzyl alcohol (BA) (20 w %)
Hardener 3: mXDA/IPD/DCH 90/5/5 (total 80 w %), BA (20 w %)
Hardener 4: PACM 50 w % IPD 45 w % DCH 5 w %
Hardener 5: PACM 40 w % IPD 36 w % DCH 4 w % BA 20 w %
Hardener 6: mXDA 50 w % DCH 45 w % IPD 5 w %
Hardener 7: EPIKURE 3370
Comparative hardener a: DETDA/salicylic acid (90/10) and 20 w % BA
Comparative hardener b: EPIKURE 161 (MDA based)

3. Formulation part: The properties of the formulation mixture, like reactivity, fiber wetting are measured on freshly prepared mixtures. The epoxy resin part and the hardener part are stored in a conditioned room at 23° C., weighted in an open tin and mixed with a large spatula at this temperature.

TABLE 1
formulations according to the invention

| Formulation | epoxy resin (R) | hardener (H) in phr* |
|---|---|---|
| A | R1 | H4 18.5 |
| B | R1 | H5 22.8 |
| C | R1 | H6 12.7 |
| D | R1 | H7 28.2 |
| E | R2 | H3 19.1 |
| F | R2 | H1 15.8 |
| G | R3 | H1 16.7 |
| H | R2 | H2 18.96 |

*phr: part per hundred resin

TABLE 2
comparative formulations

| | | hardener |
|---|---|---|
| | epoxy resin | (comp H or H) |
| Formulation | (comp R) | in phr* |
| comp 1 | comp R c | comp H b 50 |
| comp 2 | comp R a | H1 19.9 |
| comp 3 | comp R b | comp H a 37.46 |

*phr: part per hundred resin

TABLE 3
Properties

| | | | fiber wetting |
|---|---|---|---|
| | | | wetting time(min)/ |
| Formulation | reactivity* | viscosity** | spot size (mm) |
| A | 56 | 880 | 3/67 |
| B | 308 | 915 | 6/61 |
| C | 221 | 701 | 1.5/64 |
| D | 282 | 558 | 1.5/72 |
| E | 56 | 780 | not done |
| comp1 | 386 | 855 | 4/75 |
| comp2 | >400 | not done | not done |

*gel time in minutes
**in mPa · S

TABLE 4
Chemical resistance

| Formulation | water* | toluene* | aqueous HCl* |
|---|---|---|---|
| F | 1.01 | 4.03 | 2.62 |
| G | 1.22 | 3.86 | 4.70 |
| H | 1.12 | 2.92 | 2.00 |
| comp1 | 1.32 | 7.57 | 1.26 |
| comp2 | 1.16 | 2.19 | 10.73 |
| comp3 | 1.76 | 15.71 | 2.22 |

*expressed in weight % and measured after 50 days immersion as given above

1. An ambient temperature curable or polymerizable epoxy resin composition comprising an epoxy part (a) which comprises a combination of:
at least an aromatic halogenated glycidyl ether resin,
a non halogenated glycidyl ether resin,
an optional part (a) reactive diluent, and an optional part (a) solvent, and a hardener part (b) comprising an amine selected from the group consisting of aliphatic amines, cyclo-aliphatic amines, aromatic amines and combinations thereof, an optional part (b) diluent, and an optional part (b) solvent.

2. The composition of claim 1 wherein the halogenated glycidyl ether resin comprises bromine or chlorine atoms.

3. The composition of claim 1 wherein the non halogenated glycidyl ether resin comprises a glycidyl ether selected from the group consisting of a halogenated glycidyl ether from Bis-phenol A, with an epoxy group content (EGC) of from 2800 to 1100 mmol/kg, a halogenated glycidyl ether from Bis-phenol F with an epoxy group content (EGC) of from 2800 to 1100 mmol/kg, a glycidyl ether of tetrabromobis phenol A with EGC of from 2500 to 1200 mmol/kg, and combinations thereof.

4. The composition of claim 1 wherein the non halogenated glycidyl ether resin comprises a glycidyl ether selected from the group consisting of a diglycidyl ether of Bisphenol A, a diglycidyl ether of Bisphenol F, polyglycidyl ethers of phenol/cresol-formaldehyde novolacs, and combinations thereof.

5. The composition of claim 1 wherein the hardener part (b) comprises an aliphatic amine selected from the group consisting of diethylenetriamine (DETA), triethylenetetramine (TETA), teraethylenepentamine (TEPA), isophorone diamine (IPD), para-aminocyclohexane methylene (PACM), diamino cyclohexane (DCH), meta-Xylene diamine (mXDA) 4,4′-Diamino 3,3′-dimethyl diCyclohexyl methane (DDCM), adducts of aliphatic amines on DETA,TETA,TEPA,IPD,PACM,DCH, mXDA, DDCM, and combinations thereof.

6. The composition of claim 1 wherein the hardener part (b) comprises an amino selected from the group consisting of isophorone diamine (IPD), para-aminocyclohexane methylene (PACM), diamino cyclohexane (DCH), meta-xylene diamine (mXDA), adducts based on thereof, and combinations thereof.

7. A shaped article comprising the composition of claim 1.

8. A coating comprising the composition of claim 1.

9. (canceled)

10. (canceled)
